(19) United States
(12) Patent Application Publication
(10) Pub. No.: US 2019/0052878 A1
(43) Pub. Date: Feb. 14, 2019

(54) SYSTEMS AND METHODS FOR TRANSFORM COEFFICIENT CODING

(71) Applicant: Sharp Kabushiki Kaisha, Sakai City, Osaka (JP)

(72) Inventors: Jie ZHAO, Camas, WA (US); Christopher Andrew SEGALL, Camas, WA (US); Seung-Hwan KIM, Camas, WA (US); Kiran Mukesh MISRA, Camas, WA (US)

(21) Appl. No.: 16/074,781

(22) PCT Filed: Jan. 25, 2017
(86) PCT No.: PCT/JP2017/002475

§ 371 Date: Aug. 2, 2018

Related U.S. Application Data
(60) Provisional application No. 62/292,806, filed on Feb. 8, 2016.
(60) Provisional application No. 62/295,136, filed on Feb. 14, 2016.

(51) Int. Cl. H04N 19/124; H04N 19/176; H04N 19/159; H04N 19/44; H04N 19/52

(52) U.S. Cl. CPC H04N 19/124; H04N 19/176; H04N 19/52; H04N 19/45; H04N 19/159

(57) ABSTRACT

A video coding device may be configured to receive a level value, estimate a characteristic of a reconstructed video block associated with the level value, adjust a quantization scale factor based on the estimated characteristic, and perform a quantization process on the level value based on the adjusted quantization scale factor.

### CROSS REFERENCE

This Nonprovisional application claims priority under 35 U.S.C. § 119 on provisional Application No. 62/292,806 on Feb. 8, 2016, and provisional Application No. 62/295,136 on Feb. 14, 2016, the entire contents of which are hereby incorporated by reference.

### TECHNICAL FIELD

This disclosure relates to video coding and more particularly to techniques for transform coefficient coding.

### BACKGROUND ART

Digital video capabilities can be incorporated into a wide range of devices, including digital televisions, laptop or desktop computers, tablet computers, digital recording devices, digital media players, video gaming devices, cellular telephones, including so-called “smart” phones, medical imaging devices, and the like. Digital video may be coded according to a video coding standard. Video coding standards may incorporate video compression techniques. Examples of video coding standards include ISO/IEC MPEG-4 Visual and ITU-T H.264 (also known as ISO/IEC MPEG-4 AVC) and High-Efficiency Video Coding (HEVC). HEVC is described in High Efficiency Video Coding (HEVC), Rec. ITU-T H.265 October 2014, which is incorporated by reference and referred to herein as ITU-T H.265. Extensions and improvements for HEVC are currently being considered for development of next generation video coding standards. For example, the ITU-T Video Coding Experts Group (VCEG) and ISO/IEC Moving Picture Experts Group (MPEG) (collectively referred to as the Joint Video Exploration Team (JVET)) are studying the potential need for standardization of future video coding technology with a compression capability that significantly exceeds that of the current HEVC standard. The Joint Exploration Model 1 (JEM 1), Algorithm Description of Joint Exploration Test Model 1 (JEM 1), ISO/IEC JTC1/SC29/WG11/N15790, October 2015, Geneva, CH, which is incorporated by reference herein, describes the coding features that are under coordinated test model study by the JVET as potential enhanced video coding technology beyond the capabilities of HEVC. It should be noted that the coding features of JEM 1 are implemented in JEM reference software maintained by the Fraunhofer research organization. Currently, Revision 102 of the JEM reference software is available. As used herein, the term JEM is used to collectively refer to algorithm descriptions of JEM 1 and implementations of JEM reference software.

Video compression techniques enable data requirements for storing and transmitting video data to be reduced. Video compression techniques may reduce data requirements by exploiting the inherent redundancies in a video sequence. Video compression techniques may sub-divide a video sequence into successively smaller portions (i.e., groups of frames within a video sequence, a frame within a group of frames, slices within a frame, coding tree units (e.g., macroblocks) within a slice, coding blocks within a coding tree unit, coding units within a coding block, etc.). Intra prediction coding techniques (e.g., intra-picture (spatial)) and inter prediction techniques (i.e., inter-picture (temporal)) may be used to generate difference values between a unit video data to be coded and a reference unit of video data. The difference values may be referred to as residual data. Residual data may be coded as quantized transform coefficients. Syntax elements may relate residual data and a reference coding unit (e.g., intra-prediction mode indices, motion vectors, and block vectors). Residual data and syntax elements may be entropy coded. Entropy encoded residual data and syntax elements may be included in a compliant bitstream.

### SUMMARY OF INVENTION

In general, this disclosure describes various techniques for coding video data. In particular, this disclosure describes techniques for transform coefficient coding. It should be noted that although techniques of this disclosure are described with respect to ITU-T H.264, ITU-T H.265, and JEM, the techniques of this disclosure are generally applicable to video coding. For example, transform coefficient coding techniques that are described herein with respect to ITU-T H.265 may be generally applicable to video coding. For example, the coding techniques described herein may be incorporated into video coding systems, (including future video coding standards) including block structures, intra prediction techniques, inter prediction techniques, transform techniques, filtering techniques, and/or entropy coding techniques other than those included in ITU-T H.265. Thus, reference to ITU-T H.264, ITU-T H.265, and/or JEM is for descriptive purposes and should not be construed to limit the scope to of the techniques described herein.

An aspect of the invention is a method of performing a quantization process on a transform value associated with video data, the method comprising: receiving a transform value; receiving a predictive block of video data associated with the transform value; adjusting a quantization scale factor based on a function of the received predictive block of video data; and performing a quantization process on the transform value based on the adjusted quantization scale factor.

An another aspect of the invention is a method of performing a quantization process on a subset of transform values associated with video data, the method comprising: receiving set of transform values; determining a quantization parameter associated with the set of transform values; performing a quantization process on a subset of the transform values based on the determined quantization parameter; adjusting a quantization scale factor based on a function the result of the quantization process performed on the subset of the transform values; and performing a quantization process on another set of transform values based on the adjusted quantization scale factor.

An another aspect of the invention is a method of scaling a transform value associated with video data, the method comprising: receiving set of transform values; determining a scaling factor based on a first subset of the transform values applying the scaling factor to a second subset of the transform values; and performing a transform process on a set including the first subset of the transform values and the scaled second subset of transform values.

An another aspect of the invention is a method of performing a quantization process on a level value associated with video data, the method comprising: receiving a level value; estimating a characteristic of a reconstructed video block associated with the level value; adjusting a quantization scale factor based on the estimated characteristic; and performing a quantization process on the level value based on the adjusted quantization scale factor.

An another aspect of the invention is a method of performing a quantization process on level values associated with video data, the method comprising: receiving a set of level values; performing inverse quantization on the set of level values using a quantization scale factor; performing an inverse transform on the result of the inverse; adjusting the quantization scale factor based on the result of the inverse transform; and performing a quantization process on the set of level values based on the adjusted quantization scale factor.

An another aspect of the invention is a method of modifying reconstructed residual data, the method comprising: receiving reconstructed residual data; performing a transform on the reconstructed residual data; determining a scaling factor based on the result of the transform; modifying one or more transform coefficients based on the determined scaling factor; and performing an inverse transform on the modified transform coefficients.

### BRIEF DESCRIPTION OF DRAWINGS

FIG. 1 is a block diagram illustrating an example of a system that may be configured to encode and decode video data according to one or more techniques of this disclosure.

FIG. 2 is a block diagram illustrating an example of a video encoder that may be configured to encode video data according to one or more techniques of this disclosure.

FIG. 3 is a block diagram illustrating an example of an inverse quantization and inverse transform processing unit that may be configured to code video data according to one or more techniques of this disclosure.

FIG. 4A is a block diagram illustrating an example of an inverse quantization and inverse transform processing unit that may be configured to code video data according to one or more techniques of this disclosure.

FIG. 4B is a block diagram illustrating an example of an inverse quantization and inverse transform processing unit that may be configured to code video data according to one or more techniques of this disclosure.

FIG. 5A is a block diagram illustrating an example of an inverse quantization and inverse transform processing unit that may be configured to code video data according to one or more techniques of this disclosure.

FIG. 5B is a block diagram illustrating an example of an inverse quantization and inverse transform processing unit that may be configured to code video data according to one or more techniques of this disclosure.

FIG. 5C is a block diagram illustrating an example of an inverse quantization and inverse transform processing unit that may be configured to code video data according to one or more techniques of this disclosure.

FIG. 6 is a block diagram illustrating an example of a video decoder that may be configured to decode video data according to one or more techniques of this disclosure.

FIG. 7 is conceptual diagram illustrating an example of adjusting a quantization value according to one or more techniques of this disclosure.

FIG. 8A is conceptual diagrams illustrating an example of coding transform coefficients according to one or more techniques of this disclosure.

FIG. 8B is conceptual diagrams illustrating an example of coding transform coefficients according to one or more techniques of this disclosure.

FIG. 8C is conceptual diagrams illustrating an example of coding transform coefficients according to one or more techniques of this disclosure.

FIG. 9A is conceptual diagram illustrating an example of coding transform coefficients according to one or more techniques of this disclosure.

FIG. 9B is conceptual diagram illustrating an example of coding transform coefficients according to one or more techniques of this disclosure.

### DESCRIPTION OF EMBODIMENTS

Video content typically includes video sequences comprised of a series of frames. A series of frames may also be referred to as a group of pictures (GOP). Each video picture may include a plurality of slices or tiles, where a slice or tile includes a plurality of video blocks. A video block may be defined as the largest array of pixel values (also referred to as samples) that may be predictively coded. Video blocks may be ordered according to a scan pattern (e.g., a raster scan). A video encoder performs predictive encoding on video blocks and sub-divisions thereof. ITU-T H.264 specifies a macroblock including 16×16 luma samples. ITU-T H.265 specifies an analogous Coding Tree Unit (CTU) structure where a picture may be split into CTUs of equal size and each CTU may include Coding Tree Blocks (CTB) having 16×16, 32×32, or 64×64 luma samples. JEM specifies a CTU having a maximum size of 256×256 luma samples. As used herein, the term video block may generally refer to an area of a picture or may more specifically refer to the largest array of pixel values that may be predictively coded, sub-divisions thereof, and/or corresponding structures.

In ITU-T H.265, the CTBs of a CTU may be partitioned into Coding Blocks (CB) according to a corresponding quadtree block structure. In JEM, CTBs may be further partitioned according to a binary tree structure. That is, JEM specifies a quadtree plus binary tree (QTBT) block structure. According to ITU-T H.265, one luma CB together with two corresponding chroma CBs and associated syntax elements are referred to as a coding unit (CU). A CU is associated with a prediction unit (PU) structure defining one or more prediction units (PU) for the CU, where a PU is associated with corresponding reference samples. That is, in ITU-T H.265 the decision to code a picture area using intra prediction or inter prediction is made at the CU level. In ITU-T H.265, a PU may include luma and chroma prediction blocks (PBs), where square PBs are supported for intra prediction and rectangular PBs are supported for inter prediction. Intra prediction data (e.g., intra prediction mode syntax elements) or inter prediction data (e.g., motion data syntax elements) may associate PUs with corresponding reference samples. In JEM, the binary tree structure enables square and rectangular binary tree leaf nodes, which are referred to as Coding Blocks (CBs). In JEM, CBs may be used for prediction without any further partitioning. Further, in JEM, luma and chroma components may have separate QTBT structures. The difference between sample values included in a PU, CB, or another type of picture area structure and associated reference samples may be referred to as residual data.

Residual data may include respective arrays of difference values corresponding to each component of video data (e.g., luma (Y) and chroma (Cb and Cr). Residual data may be in the pixel domain. A transform, such as, a discrete cosine transform (DCT), a discrete sine transform (DST), an integer transform, a wavelet transform, or a conceptually similar transform, may be applied to pixel difference values to generate transform coefficients. It should be noted that in ITU-T H.265, PUs may be further sub-divided into Transform Units (TUs). That is, an array of pixel difference values may be sub-divided for purposes of generating transform coefficients (e.g., four 8×8 transforms may be applied to a 16×16 array of residual values), such sub-divisions may be referred to as Transform Blocks (TBs). In JEM, residual values corresponding to a CB may be used to generate transform coefficients. In JEM, an Adaptive Multiple Transform (AMT) scheme may be used for generating transform coefficients. An AMT scheme may include generating transform coefficients using a transform set, where a transform set includes defined transform matrices. Transform matrices may correspond to one of the eight versions of DCT or one of the eight versions of DST, where the eight versions of DCT and the eight versions of DST form the family of discrete trigonometric transforms. In one example, particular transform sets may correspond to intra prediction modes. Further, in JEM, a core transform and a subsequent secondary transform may be applied to generate transform coefficients. Further, whether a subsequent secondary transform is applied to generate transform coefficients may be dependent on a prediction mode. Quantization may be performed on transform coefficients. Quantized transform coefficients may be entropy coded according to an entropy encoding technique (e.g., content adaptive variable length coding (CAVLC), context adaptive binary arithmetic coding (CABAC), probability interval partitioning entropy coding (PIPE), etc.). Further, syntax elements (e.g., a syntax element indicating a prediction mode) may also be entropy coded. Entropy encoded quantized transform coefficients and corresponding entropy encoded syntax elements may form a compliant bitstream that can be used to reproduce video data.

Quantization scales transform coefficients in order to vary the amount of data required to send a group of transform coefficients. Quantization may include division of transform coefficients by a quantization scaling factor (referred to as Q_{scale} herein) and any associated rounding functions (e.g., rounding to the nearest integer). Quantized transform coefficients may be referred to as coefficient level values. Inverse quantization (or “dequantization”) may include multiplication of coefficient level values by the quantization scaling factor. It should be noted that as used herein the term quantization process in some instances may refer to division by a scaling factor to generate level values and multiplication by a scaling factor to recover transform coefficients in some instances. That is, a quantization process may refer to quantization in some cases and inverse quantization in some cases. Further, in some examples a quantization process may refer to quantization, an inverse quantization, and any subsequent quantizations (e.g., adjusting the quantization of AC transform coefficients based on a dequantized DC transform coefficient at a video encoder). Further, it should be noted that although in the examples below quantization processes are described with respect to arithmetic operations associated with decimal notation, such descriptions are for illustrative purposes and should not be construed as limiting. For example, the techniques described herein may be implemented using binary operations and the like. For example, multiplication and division operations described herein may be implemented using bit shifting operations, addition operations, and the like. Equation 1 provides a generalized example of a quantization and Equation 2 provides an example of a corresponding inverse quantization.

Level=Round_{Integer}(Coefficient/Q_{scale}) EQUATION 1

Coefficient=Level*Q_{scale} EQUATION 2

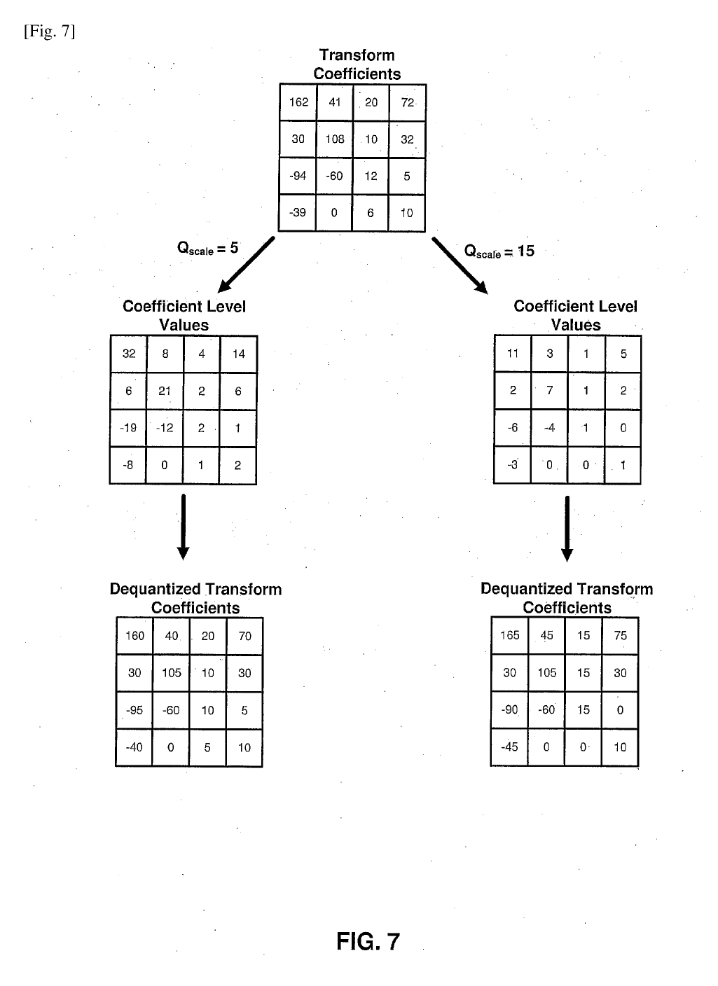

The degree of quantization may be modified by adjusting the quantization scaling factor. The degree of quantization may alter the rate-distortion (i.e., bit-rate vs. quality of video) of coded video data. Referring to Equation 1 and Equation 2, the amount of data required to send the coefficient level values and the precision of the recovered transform coefficient values (i.e., dequantized transform coefficients) may be adjusted by changing the value of Q_{scale}. FIG. 7 is a conceptual diagram illustrating how a change in the value of Q_{scale} changes the range of coefficient level values (e.g., for Q_{scale}=5, coefficient level values range from −19 to 32 and for Q_{scale}=15, coefficient level values range from −6 to 11) and the precision at which transform coefficient values may be recovered (e.g., for Q_{scale}=15 there are more coefficient levels having a value of 0).

In ITU-T H.265, the value of a quantization scaling factor, Qₛₜₑₚ, may be determined by a quantization parameter, QP. In ITU-T H.265, QP can take 52 values from 0 to 51 and a change of 1 for QP generally corresponds to a change in the value of the Qₛₜₑₚ by approximately 12%. Further, in ITU-T H.265, a QP value for a set of transform coefficients may be derived using a predictive quantization parameter value and an optionally signaled quantization parameter delta value. In ITU-T H.265, a quantization parameter may be updated for each CU and a quantization parameter may be derived for each of luma (Y) and chroma (Cb and Cr) components. In ITU-T H.265, for a current luma coding block in a coding unit, a luma quantization parameter, Qp′_{Y}, may be derived based on a predictive quantization parameter value and a quantization parameter delta value according to the following equations:

Qp′_{Y}=Qp_{Y}+QpBdOffset_{Y} EQUATION 3

Qp_{Y}=((qP_{Y}_{_}_{PRED}+CuQpDeltaVal+52+2*QpBdOffset_{Y})%(52+QpBdOffset_{Y}))−QpBdOffset_{Y} EQUATION 4
where
   QpBdOffset_{Y} is the quantization parameter range offset and is derived by QpBdOffset_{Y}=6*bit_depth_luma_minus8;
   bit_depth_luma_minus8 is equal to the bit depth of luma (bitDepthY) minus 8;
   qP_{Y}_{_}_{PRED} is equal to:
      a slice luma quantization parameter derived from variables signaled in a slice segment header, or
      the luma quantization parameter of the last coding unit in the previous quantization group in decoding order;
   CuQpDeltaVal is derived from variables signaled in transform unit syntax and has a value in the inclusive range of −(26+QpBdOffset_{Y}/2) to +(25+QpBdOffset_{Y}/2); and
   % is a modulus arithmetic operator, where x % y is remainder of x divided by y, defined only for integers x and y with x>=0 and y>0;

It should be noted that, in some examples, with respect to Equation 3 and Equation 4, QpBdOffsetY may be generalized as including any value based on the bit depth of a luma component and Equation 4 may be generalized to include any function based on a luma quantization parameter predictor value, a coding unit quantization parameter delta value, and the bit depth of a luma component. Further, it should be noted that in ITU-T H.265, CuQpDeltaVal is optionally signaled. In this manner, the process for determining a Qstep for a current luma coding block in a coding unit in ITU-T H.265 may be generally described as inheriting a slice level QP value or inheriting a QP value from a previous CU and optionally adding an indicated QP delta value to the inherited QP value. In ITU-T H.265, a QP delta value is signaled to a decoder using a one-bit sign indicator and a variable length absolute value indicator.

Further, in ITU-T H.265, chroma quantization parameters, Qp′Cb and Qp′Cr, for a coding unit are derived according to the following equations:

Qp′_{Cb}=qP_{Cb}+QpBdOffset_{C} EQUATION 5

Qp′_{Cr}=qP_{Cr}+QpBdOffset_{C} EQUATION 6
where
   QpBdOffset_{C} is the quantization parameter range offset and is derived by QpBdOffset_{C}=6*bit_depth_chroma_minus8;
   bit_depth_chroma_minus8 is equal to the bit depth of chroma (bitDepthC) minus 8;

In ITU-T H.265, the variables qPCb and qPCr are set equal to a value of QpC as specified in Table 1 based on the index qPi equal to variables qPiCb and qPiCr.

TABLE 1

| | qPi | | | | | | | | | | | | | | | |
|---|---|---|---|---|---|---|---|---|---|---|---|---|---|---|---|---|
| | <30 | 30 | 31 | 32 | 33 | 34 | 35 | 36 | 37 | 38 | 39 | 40 | 41 | 42 | 43 | >43 |
| Qp_{C} | =qPi | 29 | 30 | 31 | 32 | 33 | 33 | 34 | 34 | 35 | 35 | 36 | 36 | 37 | 37 | =qP-6 |

where qPi_{Cb} and qPi_{Cr} are derived as follow

qPi_{Cb}=Clip3(−QpBdOffset_{C},57,Qp_{Y}+pps_cb_qp_offset+slice_cb_qp_offset) EQUATION 7

qPi_{Cr}=Clip3(−QpBdOffset_{C},57,Qp_{Y}+pps_cr_qp_offset+slice_cr_qp_offset) EQUATION 8
where
   Clip3(x,y,z) equals x, if z<x; equals y, if z>y; or equals z otherwise;
   pps_cb_qp_offset is signalled in the picture parameter set and has a value in the inclusive range of −12 to +12
   pps_cr_qp_offset is signalled in the picture parameter set and has a value in the inclusive range of −12 to +12
   slice_cb_qp_offset is signalled in the slice segment header and specifies a difference to be added to pps_cb_qp_offset and has a value in the inclusive range of −12 to +12;
   slice_cr_qp_offset is signalled in the slice segment header and specifies a difference to be added to pps_cr_qp_offset and has a value in the inclusive range of −12 to +12;

It should be noted that, in some examples, with respect to Equations 5-8 QpBdOffset_{C} may be generalized as any value based on the bit depth of a chroma component and functions for qPi_{Cb} and qPi_{Cr} may be generalized to include any function based on a luma quantization parameter (or variables associated therewith) and the bit depth of a chroma component. In this manner, the process for determining a Qₛₜₑₚ for a current chroma coding block in a coding unit in ITU-T H.265 may be generally described as determining a QP value based on a QP value associated with the luma component. Thus, in ITU-T H.265 the degree of quantization applied to a set of transform coefficients may depend on (1) slice level parameters, (2) parameters inherited from a previous coding unit, and/or (3) optionally signaled CU level delta values.

It should be noted that the expected performance of a video coding standard may be based on particular video coding formats and the expected values of data within a supported video coding format. For example, a video coding standard may be based on an assumption that the majority of video data transmitted using a video system will have a specific format (e.g., a particular picture resolution, dynamic range, and color gamut). This may result in less than ideal coding when video data does not have values within the expected ranges, particularly, when video data has a greater than expected range of values. For example, a video coding standard designed based on a high-definition video format may not provide adequate performance for coding a next generation video format, e.g., a so-called ultra-high-definition format. Further, regions of a picture may have different characteristics with respect to brightness, dynamic range, and color of samples therein. For example, a portion of a scene in shadow may have different local characteristics than a portion of the scene not in shadow although both of the regions are included in the same picture. It should be noted that the likelihood of regions of a picture having different local characteristics, increases as picture size, dynamic range, and/or color gamut increase for video data. It should be noted that in some examples, these regions may be included with the same slice of video data or, in some cases, may be included in adjacent CUs.

In some cases, in order to improve coding performance, it may be desirable to apply a lower degree of quantization to transform coefficients generated for a region of an image that is relatively bright (i.e., decrease the value of Q_{scale}) and apply a higher degree of quantization to transform coefficients generated for a region of an image that is relatively dark (i.e., increase the value of Q_{scale}). That is, it may be acceptable to reconstruct dark portions of a picture (e.g., portions of a scene in a shadow) with less precision than bright portions of the picture. As described above, in ITU-T H.265, the degree of quantization applied to a set of transform coefficients may depend on (1) slice level parameters, (2) parameters inherited from a previous coding unit, and/or (3) optionally signaled CU level delta values. Signaling a QP delta value at the CU level to adjust the degree of quantization to accommodate for variations with a picture may be less than ideal. Further, it should be noted that in ITU-T H.265, because a quantization parameter is inherited from a previous CU any adjustments made for the previous CU must be accounted for the current CU. For example, in the case where a previous CU inherits a slice level QP value of 26 and an adjustment is made to the slice level QP value, e.g., QP delta for the previous CU equals 20, the current CU inherits the adjusted QP value (46 in this case). Thus, in this case in order use a QP value of 26 for the current CU, a QP delta value must be sent for the current CU (e.g., −20). This may result in less than ideal coding performance. The example techniques described herein may be used to generate quantization scaling factors for a region of video data based on sample values with the region of video data.

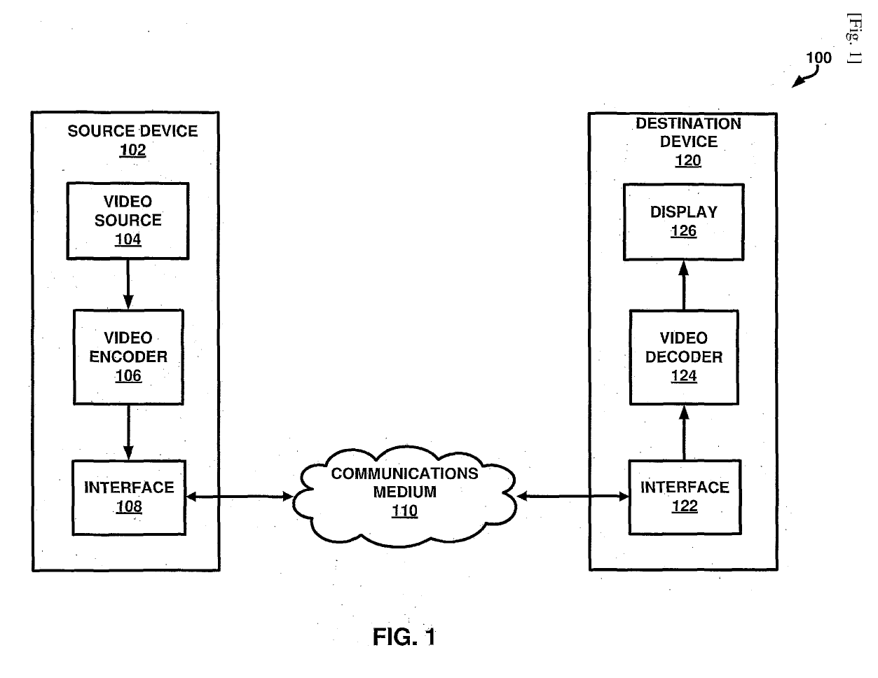

FIG. 1 is a block diagram illustrating an example of a system that may be configured to code (i.e., encode and/or decode) video data according to one or more techniques of this disclosure. System 100 represents an example of a system that may code transform coefficients according to one or more techniques of this disclosure. As illustrated in FIG. 1, system 100 includes source device 102, communications medium 110, and destination device 120. In the example illustrated in FIG. 1, source device 102 may include any device configured to encode video data and transmit encoded video data to communications medium 110. Destination device 120 may include any device configured to receive encoded video data via communications medium 110 and to decode encoded video data. Source device 102 and/or destination device 120 may include computing devices equipped for wired and/or wireless communications and may include set top boxes, digital video recorders, televisions, desktop, laptop, or tablet computers, gaming consoles, mobile devices, including, for example, “smart” phones, cellular telephones, personal gaming devices, and medical imagining devices.

Communications medium 110 may include any combination of wireless and wired communication media, and/or storage devices. Communications medium 110 may include coaxial cables, fiber optic cables, twisted pair cables, wireless transmitters and receivers, routers, switches, repeaters, base stations, or any other equipment that may be useful to facilitate communications between various devices and sites. Communications medium 110 may include one or more networks. For example, communications medium 110 may include a network configured to enable access to the World Wide Web, for example, the Internet. A network may operate according to a combination of one or more telecommunication protocols. Telecommunications protocols may include proprietary aspects and/or may include standardized telecommunication protocols. Examples of standardized telecommunications protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, Global System Mobile Communications (GSM) standards, code division multiple access (CDMA) standards, 3rd Generation Partnership Project (3GPP) standards, European Telecommunications Standards Institute (ETSI) standards, Internet Protocol (IP) standards, Wireless Application Protocol (WAP) standards, and Institute of Electrical and Electronics Engineers (IEEE) standards.

Storage devices may include any type of device or storage medium capable of storing data. A storage medium may include tangible or non-transitory computer-readable media. A computer readable medium may include optical discs, flash memory, magnetic memory, or any other suitable digital storage media. In some examples, a memory device or portions thereof may be described as non-volatile memory and in other examples portions of memory devices may be described as volatile memory. Examples of volatile memories may include random access memories (RAM), dynamic random access memories (DRAM), and static random access memories (SRAM). Examples of non-volatile memories may include magnetic hard discs, optical discs, floppy discs, flash memories, or forms of electrically programmable memories (EPROM) or electrically erasable and programmable (EEPROM) memories. Storage device(s) may include memory cards (e.g., a Secure Digital (SD) memory card), internal/external hard disk drives, and/or internal/external solid state drives. Data may be stored on a storage device according to a defined file format.

Referring again to FIG. 1, source device 102 includes video source 104, video encoder 106, and interface 108. Video source 104 may include any device configured to capture and/or store video data. For example, video source 104 may include a video camera and a storage device operably coupled thereto. Video encoder 106 may include any device configured to receive video data and generate a compliant bitstream representing the video data. A compliant bitstream may refer to a bitstream that a video decoder can receive and reproduce video data therefrom. Aspects of a compliant bitstream may be defined according to a video coding standard. When generating a compliant bitstream video encoder 106 may compress video data. Compression may be lossy (discernible or indiscernible) or lossless. Interface 108 may include any device configured to receive a compliant video bitstream and transmit and/or store the compliant video bitstream to a communications medium. Interface 108 may include a network interface card, such as an Ethernet card, and may include an optical transceiver, a radio frequency transceiver, or any other type of device that can send and/or receive information. Further, interface 108 may include a computer system interface that may enable a compliant video bitstream to be stored on a storage device. For example, interface 108 may include a chipset supporting Peripheral Component Interface (PCI) and Peripheral Component Interface Express (PCIe) bus protocols, proprietary bus protocols, Universal Serial Bus (USB) protocols, I²C, or any other logical and physical structure that may be used to interconnect peer devices.

Referring again to FIG. 1, destination device 120 includes interface 122, video decoder 124, and display 126. Interface 122 may include any device configured to receive a compliant video bitstream from a communications medium. Interface 108 may include a network interface card, such as an Ethernet card, and may include an optical transceiver, a radio frequency transceiver, or any other type of device that can receive and/or send information. Further, interface 122 may include a computer system interface enabling a compliant video bitstream to be retrieved from a storage device. For example, interface 122 may include a chipset supporting PCI and PCIe bus protocols, proprietary bus protocols, USB protocols, I²C, or any other logical and physical structure that may be used to interconnect peer devices. Video decoder 124 may include any device configured to receive a compliant bitstream and/or acceptable variations thereof and reproduce video data therefrom. Display 126 may include any device configured to display video data. Display 126 may comprise one of a variety of display devices such as a liquid crystal display (LCD), a plasma display, an organic light emitting diode (OLED) display, or another type of display. Display 126 may include a High Definition display or an Ultra High Definition display. It should be noted that although in the example illustrated in FIG. 1, video decoder 124 is described as outputting data to display 126, video decoder 124 may be configured to output video data to various types of device and/or sub-components thereof. For example, video decoder 124 may be configured to output video data to any communication medium, as described above.

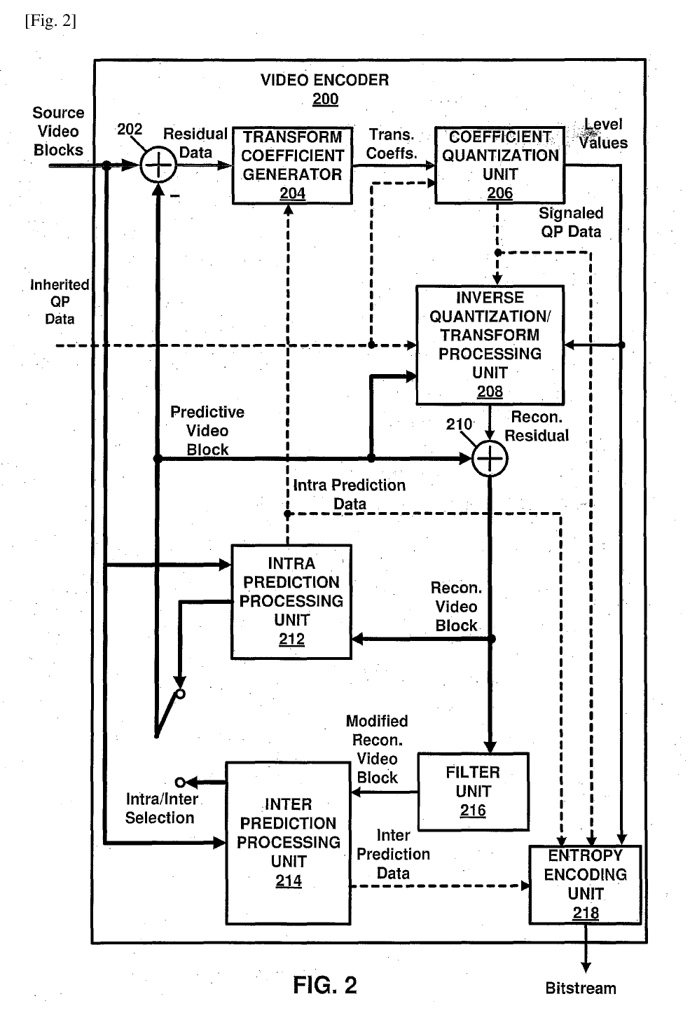

FIG. 2 is a block diagram illustrating an example of video encoder 200 that may implement the techniques for encoding video data described herein. It should be noted that although example video encoder 200 is illustrated as having distinct functional blocks, such an illustration is for descriptive purposes and does not limit video encoder 200 and/or sub-components thereof to a particular hardware or software architecture. Functions of video encoder 200 may be realized using any combination of hardware, firmware, and/or software implementations. In one example, video encoder 200 may be configured to code transform coefficients according to the techniques described herein.

Video encoder 200 may perform intra prediction coding and inter prediction coding of picture areas, and, as such, may be referred to as a hybrid video encoder. In the example illustrated in FIG. 2, video encoder 200 receives source video blocks. In some examples, source video blocks may include areas of picture that have been divided according to a coding structure. For example, source video data may include macroblocks, CTUs, CBs, sub-divisions thereof, and/or another equivalent coding unit. In some examples, video encoder 200 may be configured to perform additional subdivisions of source video blocks. It should be noted that the techniques described herein are generally applicable to video coding, regardless of how source video data is partitioned prior to and/or during encoding. Further, in the example illustrated in FIG. 2, video encoder 200 receives inherited quantization parameter data. In some examples, inherited quantization parameter data may include quantization parameter data inherited from slice level syntax or a previous coding unit (e.g., as in the case of qP_{Y}_{_}_{PRED}, described above). Further, it should be noted that inherited quantization parameter data may include any quantization parameter predictor signaled in a slice header, a sequence parameter set (SPS), a picture parameter set (PPS), or any other suitable location. In this manner, the techniques described herein should not be construed as being limited based on the illustrative examples described with respect to ITU-T H.265 and may be generally applicable to quantization parameters as defined in other video coding systems, including video coding standards currently under development.

In the example illustrated in FIG. 2, video encoder 200 includes summer 202, transform coefficient generator 204, coefficient quantization unit 206, inverse quantization/transform processing unit 208, summer 210, intra prediction processing unit 212, inter prediction processing unit 214, filter unit 216, and entropy encoding unit 218. As illustrated in FIG. 2, video encoder 200 receives source video blocks and inherited QP data and outputs a bitstream. In the example illustrated in FIG. 2, video encoder 200 may generate residual data by subtracting a predictive video block from a source video block. The selection of a predictive video block is described in detail below. Summer 202 represents a component configured to perform this subtraction operation. In one example, the subtraction of video blocks occurs in the pixel domain. Transform coefficient generator 204 applies a transform, such as a discrete cosine transform (DCT), a discrete sine transform (DST), or a conceptually similar transform, to the residual block or sub-divisions thereof (e.g., four 8×8 transforms may be applied to a 16×16 array of residual values) to produce a set of residual transform coefficients. Transform coefficient generator 204 may be configured to perform any and all combinations of the transforms included in the family of discrete trigonometric transforms. As illustrated in FIG. 2, transform coefficient generator 204 may be configured to receive intra prediction data. In this manner, transform coefficient generator 204 may be configured to perform one of more transforms on residual data based on an intra prediction mode. Similarly, transform coefficient generator 204 may be configured to perform one of more transforms on residual data based on a type of inter prediction. In JEM, one of 12 transform sets may be mapped to 67 intra prediction modes. Transform coefficients may be generated using the transform matrices associated with a transform set. In some examples, transform coefficient generator 204 may be configured to subsequently apply a secondary transform, i.e., apply a one or more subsequent secondary transform after applying a core transform. In one example, applying a subsequent secondary transform may include performing a secondary transform independently for each sub-group of transform coefficients. Transform coefficient generator 204 outputs transform coefficients to coefficient quantization unit 206. In an example, the transform coefficients output by transform coefficient generator 204 may consist of DC coefficient values corresponding to coefficients with zero frequency in both dimensions and AC coefficient values corresponding to coefficients with non-zero frequency. It should be noted that a DC coefficient value may be equal to the average value of samples in the pixel domain. Thus, in some examples, a function based on a DC coefficient value may be equivalent to a function based on a mean of pixel domain sample values and vice-versa.

Coefficient quantization unit 206 may be configured to perform quantization of the transform coefficients. As described above, the degree of quantization may be modified by adjusting a quantization scaling factor, which may correspond to a quantization parameter (QP). As illustrated in FIG. 2, coefficient quantization unit 206 receives inherited QP data, transform coefficients and outputs level values (i.e., quantized transform coefficients) and signaled QP data. Signaled QP data may refer to adjustments to inherited QP data for dequantization at a decoder. For example, signaled QP data may include the QP delta values including or similar to those described above. That is, level values and signaled QP data may be recovered by a video decoder in a lossless manner by parsing a bitstream. It should be noted, as described below, the techniques described herein may be applied, and may be particularly useful, when a bitstream includes limited signaled QP data, for example, in cases where QP delta values are not signaled.

As illustrated in FIG. 2, quantized transform coefficients are output to inverse quantization/transform processing unit 208. Inverse quantization/transform processing unit 208 may be configured to apply an inverse quantization and/or an inverse transformation to generate reconstructed residual data. As illustrated in FIG. 2, at summer 210, reconstructed residual data may be added to a predictive video block. In this manner, an encoded video block may be reconstructed and the resulting reconstructed video block may be used to evaluate the encoding quality for a given prediction, transformation, and/or quantization. Video encoder 200 may be configured to perform multiple coding passes (e.g., perform encoding while varying one or more of a prediction, transformation parameters, and quantization parameters). The rate-distortion of a bitstream or other system parameters may be optimized based on evaluation of reconstructed video blocks. Further, reconstructed video blocks may be stored and used as reference for predicting subsequent blocks.

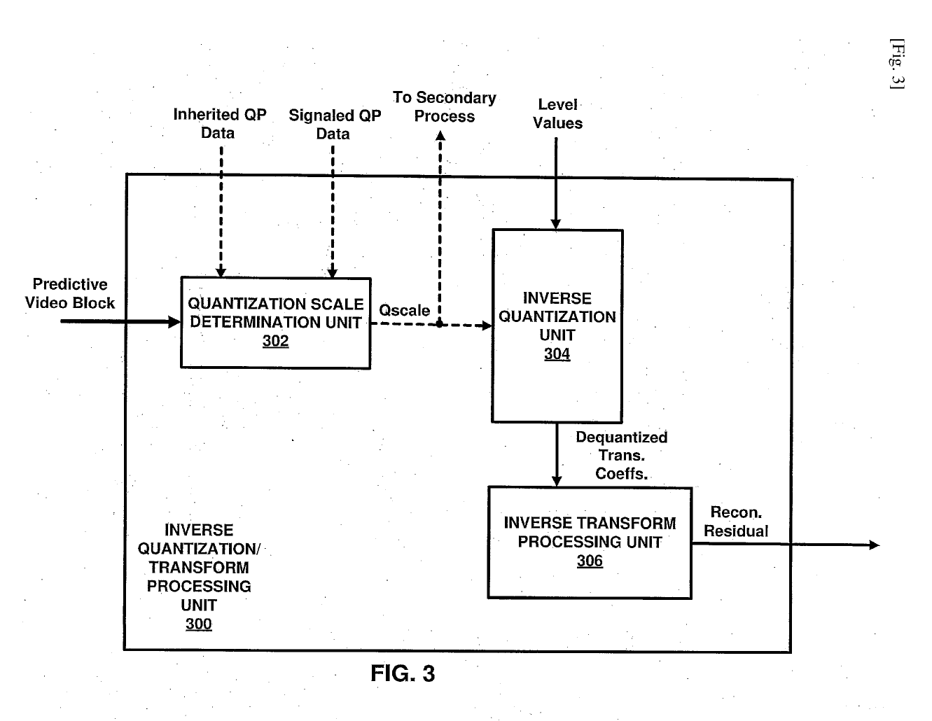

FIG. 3 is a block diagram illustrating an example of an inverse quantization and inverse transform processing unit that may be configured to code video data according to one or more techniques of this disclosure. It should be noted that inverse quantization/transform processing unit 300 may be included in a video encoder in order to perform multiple coding passes and/or a video decoder in order to perform decoding. As described above, it may be desirable to apply a lower degree of quantization to transform coefficients generated for a region of an image that is relatively bright and apply a higher degree of quantization to transform coefficients generated for a region of an image that is relatively dark. Further, it may generally be desirable to adjust the degree of quantization based on local video properties, e.g., properties of a picture area. Further, it may be desirable to adjust the degree of quantization for a current video block through minimal signaling (e.g., without signaling QP delta values), which may result in a lower bit-rate.

Inverse quantization/transform processing unit 300 may be configured to determine a quantization scale value based on inherited QP data, signaled QP data, and a predictive video block and generate reconstructed residual data based on the determined quantization scale value. As illustrated in FIG. 3, inverse quantization/transform processing unit 300 includes quantization scale determination unit 302, inverse quantization unit 304, and inverse transform processing unit 306. As illustrated in FIG. 3, inverse quantization unit 304 receives level values and a Q_{scale} value and outputs dequantized transform coefficients. That is, inverse quantization unit 304 may multiply Q_{scale} and level values and perform any associated dequantization adjustment to generate dequantized transform coefficients, as described above. Inverse transform processing unit 306 may be configured to operate in a reciprocal manner to transform coefficient generator 204. That is, inverse transform processing unit 306 may be configured to apply an inverse DCT, an inverse DST, an inverse integer transform, or a conceptually similar inverse transform process, to transform coefficients in order to reproduce residual blocks in the pixel domain. It should be noted that in the case where one of more subsequent secondary transforms are applied after a core transform, an inverse transform process includes applying reciprocal subsequent secondary transforms before applying an inverse transform process for the core transform.

Referring again to FIG. 3, quantization scale determining unit 302 receives inherited QP data, signaled QP data, and a predictive video block and determines a Q_{scale} value. As described above, a quantization scaling factor may be determined by a quantization parameter QP for a transform unit (QP_{TU}), where QP_{TU} for a transform unit is based on a predicted quantization parameter (QP_{pred}) and, optionally, a signaled quantization parameter delta value (QP_{delta}). Quantization scale determining unit 302 may be configured to determine a Q_{scale} value by adjusting QP_{TU}. That is, quantization scale determining unit 302 may be configured to determine a quantization parameter adjustment, QP_{adjust}, and add QP_{adjust} to QP_{pred} and QP_{delta}. Equations 9 and 10 illustrate the relationship between QP_{scale} and QP_{adjust}. It should be noted that in some examples, quantization scale determination unit 302 may output a QP_{adjust} to inverse quantization unit 304 and inverse quantization unit 304 may determine Q_{scale}. Further, it should be noted that one or more components described herein may perform conversions between scale values and quantization parameter values. Further, it should be noted that one or more components described herein may convert between scale values for a luma component and quantization parameter values for a chroma component. That is, for example, Table 1 and Equations 5-8 described above may be used to perform conversions between scale values for a luma component and quantization parameter values for a chroma component. That is, the techniques of this disclosure may be generally applicable to adjusting the degree of quantization based on local properties of video data regardless using any number of conversions and any combination of hardware, firmware and/or software implementations.

Q_{scale}=Function(QP_{TU}) EQUATION 9

QP_{TU}=QP_{pred}+QP_{delta}+QP_{adjust} EQUATION 10

As described above, it may be desirable to apply a lower degree of quantization to transform coefficients generated for an area of a picture that is relatively bright and apply a higher degree of quantization to transform coefficients generated for an area of a picture that is relatively dark. Table 2 provides an example of a lookup table that may be used to determine the value of QPadjust based on a relative brightness value.

TABLE 2

| | Brightness | | | | | | | | |
|---|---|---|---|---|---|---|---|---|---|
| | 10% | 20% | 30% | 40% | 50% | 60% | 70% | 80% | 90% |
| QP_{adjust} | +20 | +10 | +5 | +3 | 0 | −3 | −5 | −10 | −20 |

As described above, inverse quantization/transform processing unit 300 may be included in a video decoder in order to perform decoding. At a video decoder, dequantization is required to reconstruct an area of a picture and as such the brightness of an area of a reconstructed picture can only be estimated prior to dequantization. As such, quantization scale determination unit 302 may be configured to determine QP_{adjust} as a function of an estimated reconstructed video block, as provided in Equation 11.

QP_{adjust}=Function(Estimated reconstructed video block) EQUATION 11

As described above, a reconstructed block of video includes the sum of a predictive video block (e.g., specified using an intra prediction mode, a motion vector, etc.) and a reconstructed residual. In this manner, an estimated reconstructed video block may be based on a predictive video block and/or an estimated reconstructed residual. That is, as provided in Equations 12-14, QP_{adjust} may be a function of a predictive video block and/or an estimated reconstructed residual.

QP_{adjust}=Function(Predictive video block) EQUATION 12

QP_{adjust}=Function(Estimated Reconstructed Residual) EQUATION 13

QP_{adjust}=Function(Predictive video block,Estimated Reconstructed Residual) EQUATION 14

In the example illustrated in FIG. 3, quantization scale determination unit 302 may be configured to determine QP_{adjust} as a function of a predictive video block. In one example, quantization scale determination unit 302 may be configured perform statistical analysis with respect to samples of a predictive video block and generate a value for QP_{adjust}. That is, quantization scale determination unit 302 may estimate a relative brightness for an area of a picture by performing a statistical analysis on an associated predictive block, and generate a value for QP_{adjust}, as provided in Equation 15.

QP_{adjust}=slope*LUT[Statistic(Predictive video block)] Equation 15

In Equation 15, LUT refers to a lookup table (LUT), and Statistic may include any and all combinations of median, mean, maximum value, minimum value, standard deviation, and the like. Further, in Equation 15, slope may be a constant value used for scaling. Table 3 provides an example of a lookup table associating a mean sample value (e.g., mean of values ranging from 0 to 255, where 0 is the minimum brightness value and 255 is the maximum brightness value).

TABLE 3

| | Mean | | | | | | | | |
|---|---|---|---|---|---|---|---|---|---|
| | 0-50 | 51-75 | 76-100 | 101-125 | 126-150 | 151-175 | 176-200 | 201-225 | 226-255 |
| QP_{adjust} | +20 | +10 | +5 | +3 | 0 | −3 | −5 | −10 | −20 |

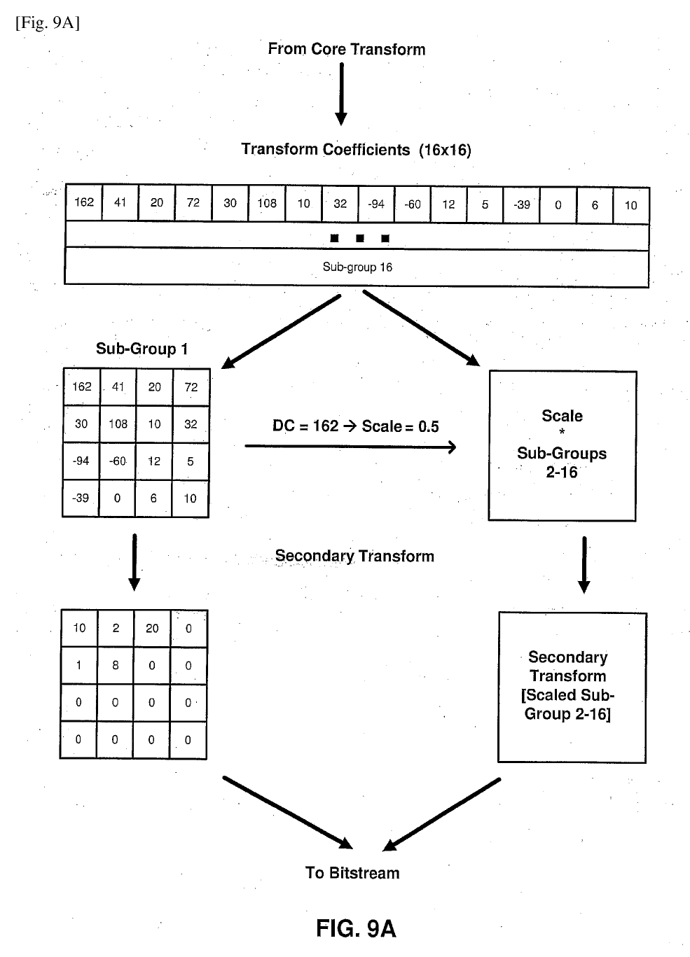

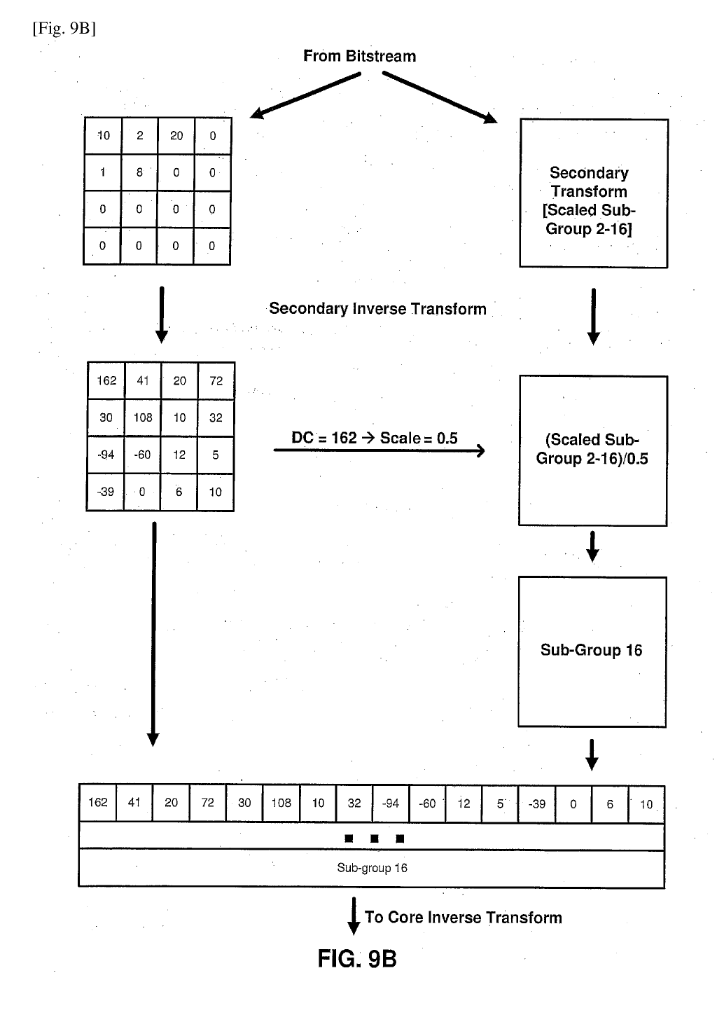

Referring again to FIG. 3, Q_{scale} is illustrated as being output by inverse quantization/transform processing unit 300 to a secondary process. In one example, a secondary process may refer to dequantization of transform coefficients for another component of video data. For example, inverse quantization/transform processing unit 300 may output reconstructed residual data for one of Y, Cb, or Cr and Q_{scale} may be provided to another inverse quantization/transform processing unit for reconstructing residual data for one of Y, Cb, or Cr. For example, if inverse quantization/transform processing unit 300 outputs reconstructed residual data for Y, dequantization of level values of Cb and Cr may be based on Q_{scale} (e.g., QP_{adjustChroma}=Function(Q_{scale})). Further, a secondary process may include a filtering process (e.g., deblocking, adaptive loop filtering, or sample adaptive offset filtering). Further, a secondary process may include scaling of transform coefficients. Scaling of transform coefficients is described in further detail below with respect to FIGS. 9A-9B. It should be noted that in some examples, sending information to a Q_{scale} value and other associated information may enable operations to be completed sooner than if reconstructed residual data is sent to the process. That is, for example, in some cases the techniques for estimating a reconstructed video block describe herein may be useful for replacing values of a reconstructed video block in other operations.

As described above, in some cases, CUs may be divided into PUs and PUs may be further sub-divided into TUs. It should be noted that in some examples, a statistic (e.g., mean value) that is used in to determine QP_{adjust} may be calculated from a block size that is different than the transform block. For example, in some cases a CU may include multiple PUs and PUs may include multiple TUs. In some examples, QP_{adjust} for each TUs may be based on the statistics of the CU. For example, after all predictions are complete for the CU, a mean brightness value may be calculated for the CU, and it may be used for calculating QP_{adjust} for each respective TU. As described above, a secondary process may include a deblocking process. In one example, a deblocking process may be based on a QP value. In one example, when determining a QP value to be used for deblocking, a QP for deblocking may be computed using a region that is greater than the TU size. That is, in one example QP_{adjust} may be determined on a TU by TU basis to adjust a QP for quantization and a QP for deblocking may be determined on a CU level. In one example, each of the respective TU QP_{adjust} values may be averaged and the averaged QP_{adjust} value may be used to determine a CU level QP value for controlling a deblocking filter. In other examples, a maximum, minimum, or median value may be determined from each of the respective TU QP_{adjust} values and this value may be used to determine a CU level QP value for controlling a deblocking filter.

As further described above, a secondary process may include dequantization of transform coefficients for another component of video data. In this case, a statistic (e.g., mean, median, minimum, maximum, etc.) of the respective TU QP_{adjust} values for one component may be used to determine a QP value for another component. For example, an average of the respective TU QP_{adjust} values for a luma component may be used to determine an adjustment for a QP value for a chroma component. In another example, a statistic of co-located luma TU may be used to adjust the chroma QP. In one example, a QP adjustment may be signaled in the bit-stream for deblocking and/or chroma dequantization, e.g., a “delta Deblock QP” and/or “delta Chroma QP” that is not used for dequantizing the luma transform coefficients may be signaled. It should be noted that scaling of transform coefficients as described in detail below with respect to FIGS. 9A-9B may also be calculated from a block size that is different than the transform block.

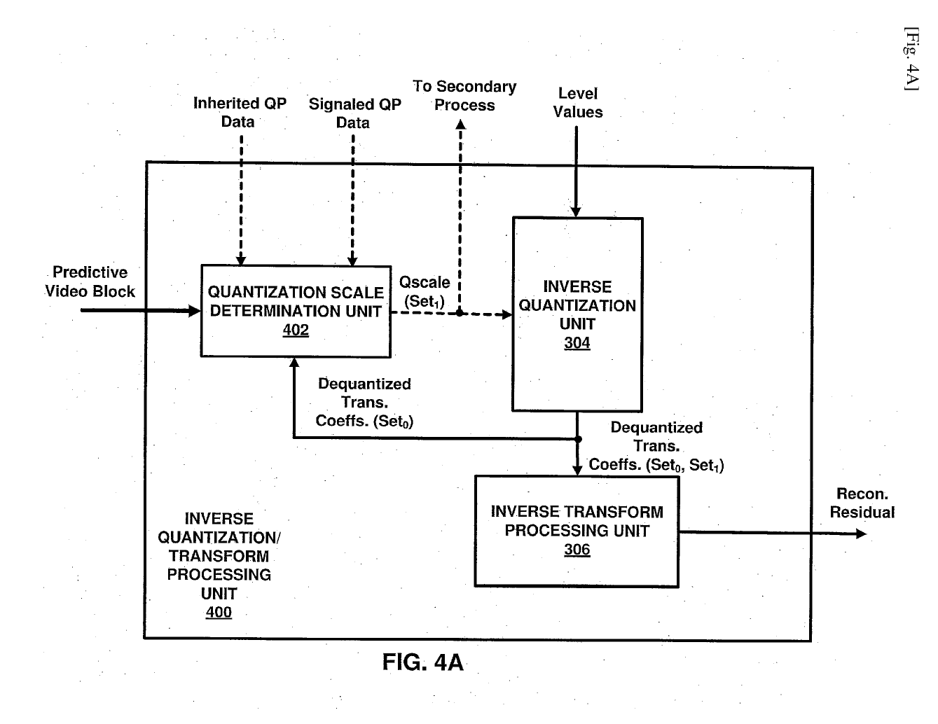

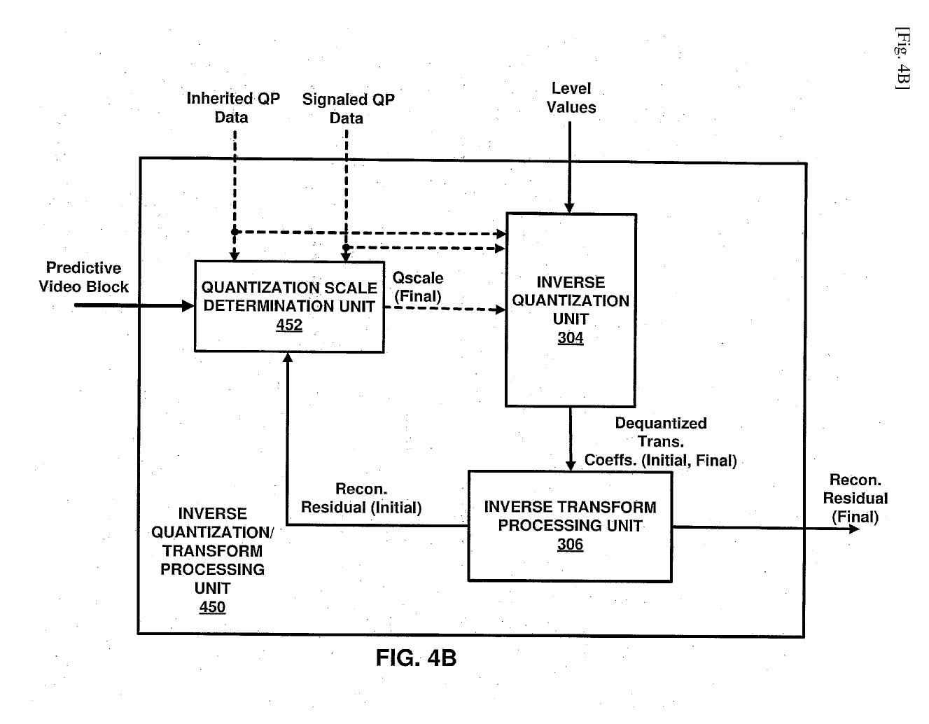

As described above, QP_{adjust} may be a function of an estimated reconstructed residual. Referring to FIG. 4A, inverse quantization/transform processing unit 400 may be configured to determine a quantization scale value based on inherited QP data, signaled QP data, a predictive video block, and/or an estimated reconstructed residual and generate reconstructed residual data based on the determined quantization scale value. As illustrated in FIG. 4A, inverse quantization/transform processing unit 400 includes inverse quantization unit 304 and inverse transform processing unit 306, as described above with respect to FIG. 3, and further includes quantization scale determining unit 402.

As illustrated in FIG. 4A, quantization scale determining unit 402 receives inherited QP data, signaled QP data, a predictive video block, a subset of dequantized transform coefficients (Set₀) and determines a Q_{scale} value for a subset of dequantized transform coefficients (Set₁). That is, in the example illustrated in FIG. 4A, QP_{adjust} for a set of level values may be a function of a partially set of dequantized transform coefficients. For an N×N matrix of level values, a set of dequantized transform coefficients may be defined according to Equation 16, a first subset of dequantized transform coefficients may be defined according to Equation 17, and a second subset of dequantized transform coefficients may be defined according to Equation 18. It should be noted that with respect to Equations 17 and 18, the value of k may be dependent on a transform type and/or prediction data (e.g., an intra prediction mode).

Dequantized Transform Coefficients=Level_{(i,j)}*Q_{scale(i,j)} Equation 16

For i=0 to k, j=0 to k:

Q_{scale(i,j)}=Q_{scaleK}=QP_{pred}+QP_{delta}+QP_{adjustK} Equation 17

For i=k+1 to N, j=k+1 to N:

Q_{scale(i,j)}=Q_{scaleN}=QP_{pred}+QP_{delta}+QP_{adjustN} Equation 18

It should be noted that in some examples, QP_{pred} and QP_{delta} may include different respective values in each of Equation 17 and Equation 18. For example, in some cases, QP_{pred} may be equal to zero for Equation 17 and may include a non-zero value for Equation 18. Further, as provided in Equation 19, a Q_{scale} value for a second set of level values may be dependent on a first subset of dequantized transform coefficients.

QP_{adjustN}=Function(Level_{(0 to k,0 to k)}*Q_{scaleK})

or

QP_{adjustN}=Function(QP_{adjustK}) Equation 19

That is, as provided in Equation 19, a lookup table, a scaling operation, or another mapping operation for a first subset of dequantized transform coefficients may be used to perform dequantization for a second set of transform coefficients. It should be noted that in some examples, in a manner similar to that described above, with respect to FIG. 3, QP_{adjustK} may be determined by a function based on a predictive video block (e.g., QP_{adjustK}=LUT[Statistic(Predictive video block)]). Further, it should be noted that in some examples, QP_{adjustK} may further be a function of a DC Coefficient Level Value. For example, QP_{adjustK} may increase or decrease based on whether the sign of a DC Coefficient Level Value is positive.

In one example, a first subset of transform coefficients may include the dequantized DC transform coefficient (i.e., (0,0)). Table 4 provides an example of a lookup table that provides a value for QP_{adjustN} corresponding to a value of a dequantized DC transform coefficient. Referring to Table 4, in one example, QP_{pred} may be equal to a slice level QP. In one example, QP_{pred} may be equal to a slice level QP and may optionally include an added delta QP value signaled in the bit-stream. In one example, delta QP signaling and/or inheriting a QP value from a previous block may be disabled and QP_{pred} may be equal to a slice level QP. It should be noted that in this case, a QP value may be signaled only at the slice level, which may result in bit-savings.

TABLE 4

| | Level_{(0,0)}*QP_{pred} | | | | | | |
|---|---|---|---|---|---|---|---|
| | 0-50 | 51-100 | 101-125 | 126-175 | 176-200 | 156-205 | 206-255 |
| QP_{adjustN} | +20 | +10 | +5 | 0 | −5 | −10 | −20 |

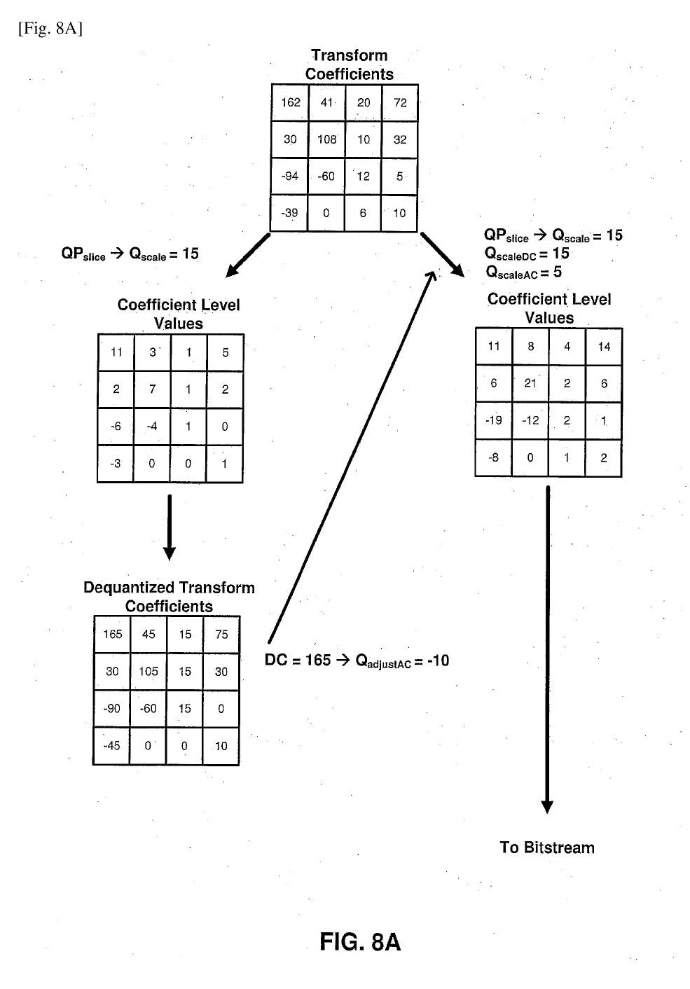

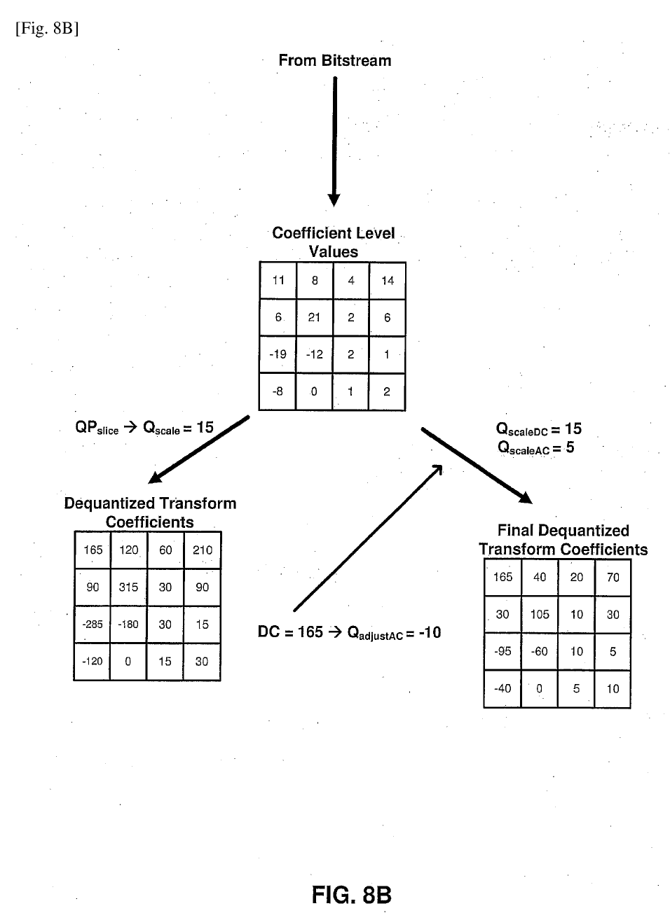

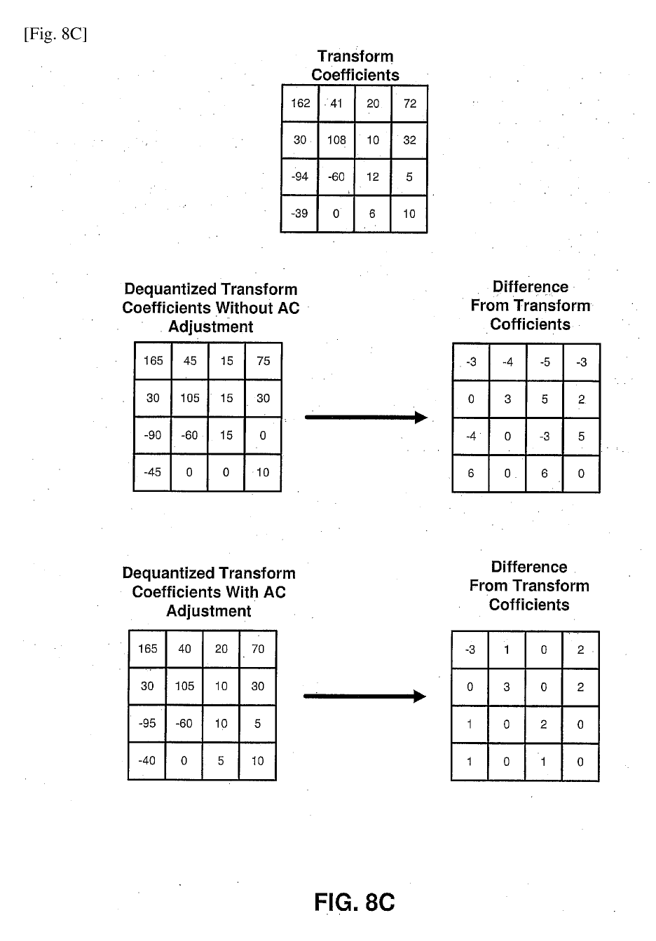

FIGS. 8A-8C are conceptual diagrams illustrating an example of coding transform coefficients according to the example provided in Table 4 and further illustrated an example of Equations 16-19. FIG. 8A illustrates an example of adjusting the quantization of AC transform coefficients based on a dequantized DC transform coefficient at a video encoder. FIG. 8B illustrates an example of adjusting the dequantization of AC transform coefficients based on a dequantized DC transform coefficient at a video decoder. Referring to FIG. 8A, a slice level quantization parameter corresponds to a Q_{scale} value of 15. Quantization of a DC coefficient and subsequent dequantization of the DC level value is used to determine an adjustment of Q_{scale} for quantization of the AC transform coefficients. The coefficient level values based on quantization using Q_{scaleDC} and Q_{scaleAC} are included in a bitstream. Referring to FIG. 8B, the coefficient level values based on the quantization using Q_{scaleDC} and Q_{scaleAC} are recovered from the bitstream. In the example illustrated in FIG. 8B, the slice level quantization parameter is used to dequantize the DC level value. It should be noted that in other examples, a local QP value used to dequantize the DC level value may include any of the predicted QP values as described above (e.g., the predicted QP from the last CU+the delta_QP in the bit-stream). The dequantized DC transform coefficient value corresponds to an adjustment of Q_{scale} for dequantization of the AC level value. The AC coefficient level values are dequantized using Q_{scaleAC}. The dequantized DC transform coefficient (dequantized using Q_{scaleDC}) and the dequantized AC transform coefficients (dequantized using Q_{scaleAC}) are combined to for a final set of dequantized transform coefficients. FIG. 8C illustrates how adjusting the dequantization of AC transform coefficients based on a dequantized DC transform coefficient in the example illustrated in FIGS. 8A-8B results in greater precision of transform coefficients at a video decoder, without the need for additional signaling.

Referring to FIG. 4A, Q_{scale} is illustrated as being output by inverse quantization/transform processing unit 400 to a secondary process. As described above, a secondary process may refer to dequantization of transform coefficients for another component of video data. In one example, inverse quantization/transform processing unit 400 may be configured to determine a Q_{scale} factor for the AC coefficients of a luma block from the dequantized luma DC value and the mean of a predictive video block. The scale factor may be applied to the AC coefficients of the luma block and the DC and AC coefficients of the chroma blocks (e.g., chroma blocks collected with the luma block). In this example, the QP value for the block may be equal to a slice level QP plus a delta QP signaled in the bit-stream.

It should be noted that in some examples a Q_{scale} value for a dequantizing a set of level values may be dependent on reconstructed residual data generated using a set of dequantized transform coefficients resulting from dequanitzing the set of level values using a first QP value. That is, in some examples, a Q_{scale} value may be determined using iterative dequantization and/or inverse transform processes. Referring to FIG. 4B, inverse quantization/transform processing unit 450 may be configured to determine a quantization scale value based on a predictive video block, inherited QP data, signaled QP data, and a reconstructed residual generated using inherited QP data and signaled QP data and further generate final reconstructed residual data based on the determined quantization scale value. As illustrated in FIG. 4B, inverse quantization/transform processing unit 450 includes inverse quantization unit 304 and inverse transform processing unit 306, as described above with respect to FIG. 3, and further includes quantization scale determination unit 452. In the example illustrated in FIG. 4B, an initial set of reconstructed residual data may be generated based on inherited QP data and signaled QP data. Quantization scale determination unit 452 receives the initial set of reconstructed residual data and determines a Q_{scale} value based on the initial set of reconstructed residual data. Inverse quantization unit 304 generates final dequantized transform coefficients based on the Q_{scale} value and inverse transform processing unit 306 generates final reconstructed residual data from the final dequantized transform coefficients.

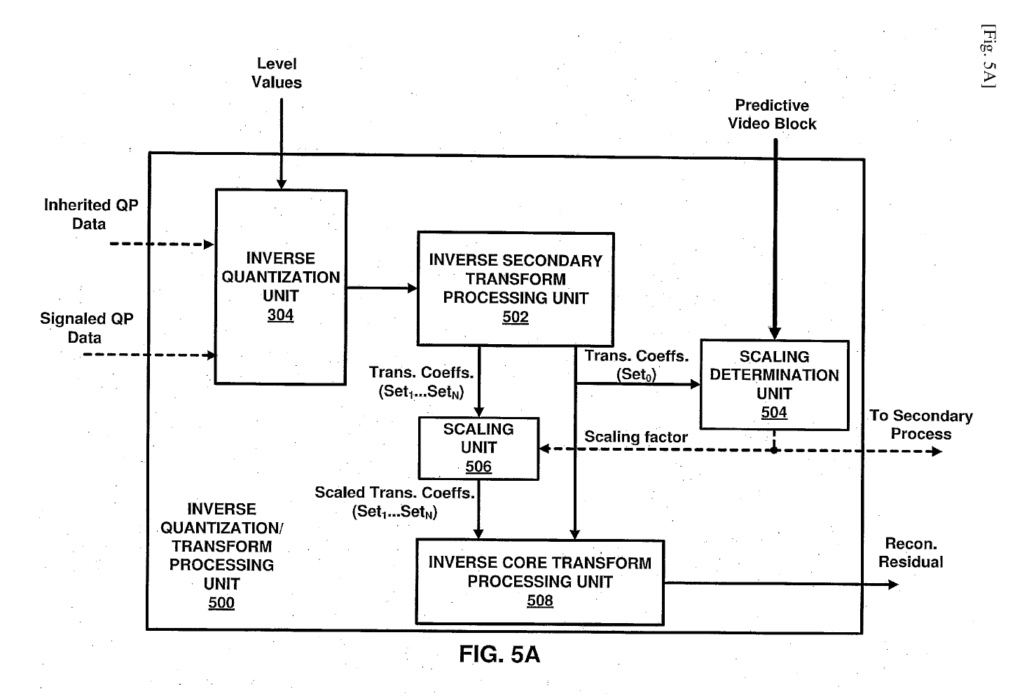

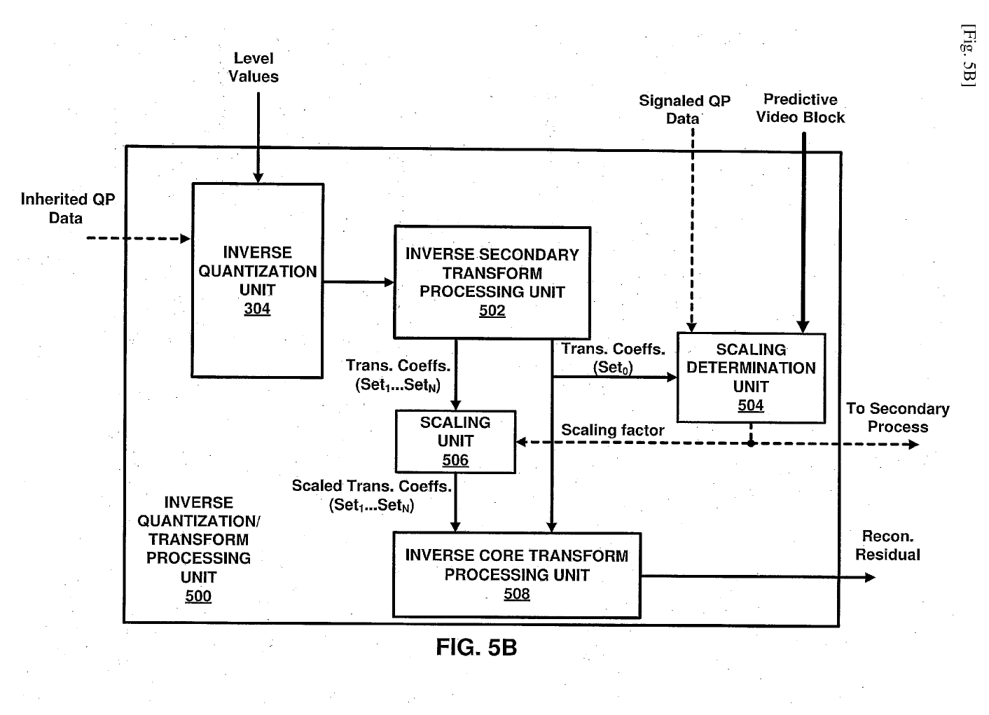

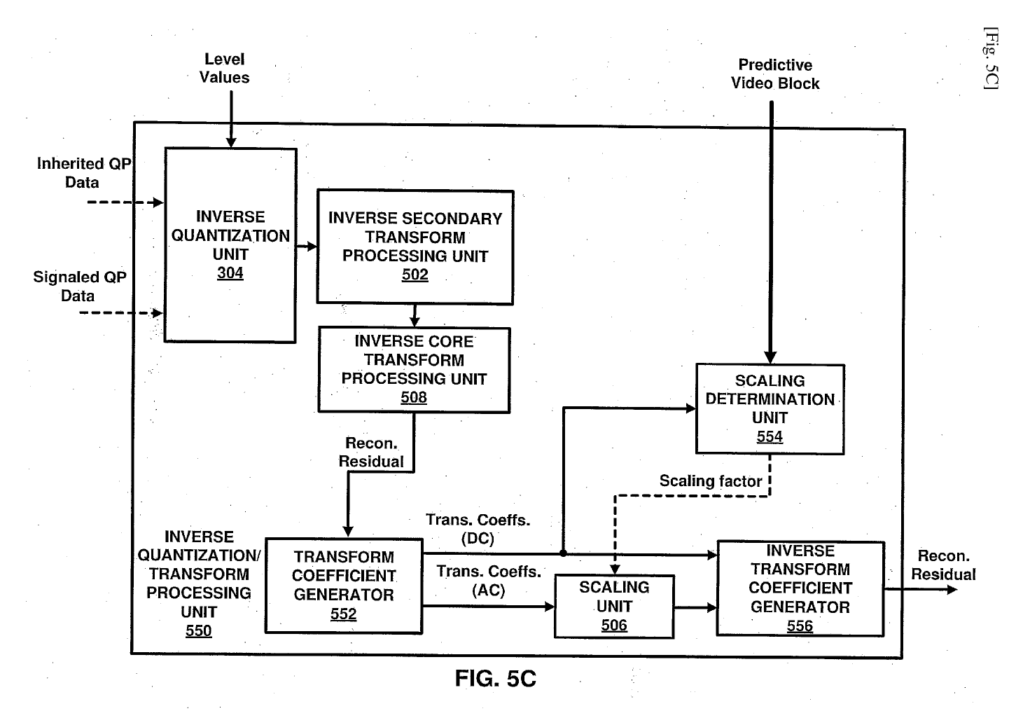

As described above, in some examples, transform coefficient generator 204 may be configured to apply a subsequent secondary transform after applying a core transform. In this case, performing an inverse transform process includes performing a secondary inverse transform and subsequently performing a core inverse transform. It should be noted that in some cases, a two dimension transform process may be performed by performing a first one dimensional transform (e.g., vertical) and a subsequent one dimensional transform (e.g., horizontal). In this manner, the techniques described herein may be generally applicable to transform processes including one or more subsequent transforms. Referring to FIG. 5A and FIG. 5B, inverse quantization/transform processing unit 500 may be configured to scale transform coefficient values generated after a first inverse transform process has been applied. As illustrated in FIG. 5A and FIG. 5B, inverse quantization/transform processing unit 500 includes inverse quantization unit 304 as described above with respect to FIG. 3 and further includes inverse secondary transform processing unit 502, scale determination unit 504, scaling unit 506, and inverse core transform processing unit 508.

Inverse secondary transform processing unit 502 may be configured to perform an inverse transform process for a secondary transform according to any of the transform techniques described herein. For example, if a core transform is performed on an N×N block of residual sample values, thereby generating an N×N block of transform coefficients, and a subsequent transform is performed on a K×K sub-block of the N×N block of transform coefficients, thereby generating a K×K block of transform coefficients, inverse secondary transform processing unit 502 may be configured to perform an inverse transform on the K×K block of transform coefficients in order to recover the K×K sub-block of the N×N block of transform coefficients. FIG. 9A illustrates an example where for a 16×16 block of transform coefficients, a secondary transform is performed on 4×4 sub-block formed from a row transform coefficients. Inverse core transform processing unit 508 may be configured to perform an inverse transform process for a core transform according to any of the transform techniques described herein. For example, with respect to the example illustrated in FIGS. 9A-9B, for a 16×16 block of transform coefficients, inverse core transform processing unit 508 may be configured to perform an inverse transform process to recover a 16×16 block of residual sample values.

In the example illustrated in FIG. 5A, scaling determination unit 504 receives a predictive block of video data and a first set of transform coefficients from inverse secondary transform processing unit 502 and outputs a scaling factor. A first set of transform coefficients received by scaling determination unit 504 may include a recovered K×K sub-block corresponding to an N×N block of transform coefficients. Referring to FIG. 9B, a first set of transform coefficients from an inverse secondary processing unit includes a 4×4 block of transform coefficients corresponding to the first row of a 16×16 block of transform coefficients. Scaling determination unit 504 may be configured to determine a scaling factor for additional sets of transform coefficients generated by inverse secondary transform processing unit 502. For example, referring to FIG. 9B, additional sets of transform coefficients generated by inverse secondary transform processing unit 502 includes 4×4 blocks of transform coefficients corresponding to the second to the sixteenth row of the 16×16 block of transform coefficients. It should be noted that in some examples, the output of inverse secondary transform processing unit 502 may be allowed to be overcomplete. That is, the number of transform coefficients output by inverse secondary transform processing unit 502 may not be equal to the number of residual samples in a block (e.g., the number of transform coefficients may be greater than the number of residual samples in the block).

As illustrated in FIG. 5A, a scaling factor for additional sets of transform coefficients may also be a function of a predictive video block. As illustrated in FIG. 5B, a scaling factor for additional sets of transform coefficients may also be a function of signaled QP data. For example, in the example illustrated in FIG. 5B, a scaling factor may be a function of a delta QP value received in a bitstream. It should be noted that in the example illustrated in FIG. 5B, in some cases, when the delta QP value is used to determine a scaling factor, inverse quantization unit 304 may be configured to disregard the delta QP value when dequantizing level values. Scaling unit 506 may be configured to receive the scaling factor and multiply or divide the values of transform coefficients included in the additional sets of transform coefficients by the scaling factor. As illustrated in the example of FIG. 5A and FIG. 5B, inverse core transform processing unit 508 receives the first set of transform coefficients (Set₀) and the scaled sets of transform coefficients (Scaled Set₁ to Set_{N}) and performs an inverse transform to generate reconstructed residual sample values. FIGS. 9A-9B further illustrated an example of scaling sub-groups of transform coefficients associated with a core transform based on characteristics of another sub-group. That is, in FIG. 9A, at an encoder, prior to performing the secondary transform the values of sub-groups 2-16 (rows 2-16 in a 16×16 transform coefficient matrix) are scaled based on the value of sub-group 1 (row 1 in the 16×16 transform coefficient matrix) and in FIG. 9B, the value of sub-group 1 is recovered and the values of sub-groups 2-16 are scaled prior to performing the inverse secondary transform. In this manner, precision may be increased for transport processes including multiple subsequent transform operations.

As described above with respect to FIG. 4B, in some examples, a Q_{scale} value may be determined using iterative dequantization and/or inverse transform processes. In a similar manner, in some examples a scaling factor may be determined using an initial set of reconstructed residual data. As further described above, a DC coefficient value may be equal to the average value of samples in the pixel domain. FIG. 5C represents an example where a DC coefficient value is used to determine a scaling factor. Referring to FIG. 5C, inverse quantization/transform processing unit 550 includes inverse quantization unit 304, inverse secondary transform processing unit 502, scaling unit 506, and inverse core transform processing unit 508 as described above and further includes, transform coefficient generator 552, scale determination unit 554, and inverse transform coefficient generator 556.

In the example illustrated in FIG. 5C, transform coefficient generator 552 receives reconstructed residual data and may be configured to perform a transform such that a statistic associated with the reconstructed residual data may be determined. In the example, illustrated in FIG. 5C, transform coefficient generator 552 outputs a DC transform coefficient to scaling determination unit 554, i.e., a mean value of the reconstructed residual. Scaling determination unit 554 also receives predictive video block and in some examples may be configured to determine a scaling factor based on the mean value of the reconstructed residual and/a statistic of the predictive video block (e.g., mean, median, minimum, maximum, etc.). Inverse transform coefficient generator 556 may be configured to receive a DC transform coefficient and scaled AC transform coefficient and perform the reciprocal of the transform performed by transform coefficient generator 552. It should be noted that in some examples, one or more other functions, including lookup tables associated with a scale factor, may be used to modify transform coefficients and/or residual values. In one example, modifying transform coefficients and/or residual values may include filtering operations, applying the scaling independently to channels, and/or combining the channels into a modified residual signal. It should be note that although in the example illustrated in FIG. 5C, scaling determination unit 554 is shown as receiving a DC transform coefficient, in other examples scaling determination unit 554 may receive any number of transform coefficients and perform any number of statistical analysis methods on the transform coefficients. For example, scaling determination unit 554 may receive a complete set of coefficients and perform determine the variance of the coefficients.

It should be noted that in some examples, the techniques described above with respect to FIG. 3 and FIGS. 4A-4B may be used in combination with the techniques described with respect to FIG. 5A-5C. That is, for example, inverse quantization unit 304 illustrated in FIGS. 5A-5C may be configured to dequantize transform coefficients according to the techniques described above with respect to FIG. 3 and/or FIG. 4A-4B. Further, it should be noted that the scaling techniques described with respect to FIG. 5A-5C may be used for intermediate scaling a first one dimensional transforms and a subsequent one dimensional transform. Further, it should be noted that the scaling techniques described with respect to FIG. 5A-5C may be used for intermediate scaling between a transform associated with a first video component (e.g., luma) and a subsequently performed transform associated with a second video component (e.g., chroma). In this manner, the techniques described with respect to FIG. 5A-5C may be general applicable to scaling transform values for various types of subsequently performed transform processes.

It should be noted that with respect to the examples described above, in some cases a QP value corresponding to a block of video data may not be signaled (e.g., a block has no coded coefficients) and, as such, the block may be skipped. In one example, in the case where a block is skipped, an updated QP value may be created from a prediction statistic and used for subsequent processing of the chroma blocks (which may have coefficients) and/or deblocking. In some examples, for this type of video block, QP may be updated to QP_{Y}_{_}_{PRED} (e.g., according to the process described in ITU-T H.265). Further, as described above, in some examples, only a slice-level QP value may be needed for dequantization, however, in some cases, other functions (e.g., deblocking) may require CU level QP values, in some examples CU level QP values may be maintained and provided for use in other functions.

Further, it should be noted that in some examples, the use of QP_{adjust} and/or QP delta signal may be controlled by high-level indicators. For example, a high-level flag (e.g. “delta_qp_inferrence”) may be used to indicate the usage of QP_{adjust} and not QP_{delta} in Equation 10 above. In one example, a high-level flag (e.g. “adjust_qp”) may control the use of QP_{adjust}. Further, a high-level flag may referred to a flag placed in a Sequence Parameter Set (SPS), a Picture Parameter Set (PPS), or a slice header. Further, in one example, there may be additional high-level flags to further indicate that there may be a difference between a desired QP (which may be derived from the original luma value) and inferred QP (which may be derived from DC coefficient and predicted luma), which may enable the difference to be signaled using the example QP delta signaling described above. In some examples, the additional high-level flags may or may not be dependent on the example “delta_qp_inferrence” flag.

Further, in some examples, one or more low-level flags in a CU, PU, and/or TU may be used to indicate the usage of one or more of the techniques described above. In one example, the one or more low-level flags may be used to indicate how to derive a scale factor (or a delta QP value). For example, in order to derive a delta QP value, a predicted luma value may be used or predicted luma value plus a DC coefficient. In another example, the usage of one or more of the techniques described above may be inferred in CU, PU, or TU level based on given conditions such as the type of transform or prediction mode. In one example, if a referenced CU or TU does not provide useful information such as a DC value, from which a desired QP can be derived, then in some examples, it may be inferred if one or more of the techniques described above is used. For example, when a DST is used, in some cases, it may not be desirable to use one or more of the techniques described above, because a DC value from a DST may not provide useful information to estimate a desired QP. Thus, in some cases, instead of a DST being used to determine a delta QP (or scale factor), a derivation using one or more different techniques, including using one more of the delta QP techniques described above, may be used.

It should be noted that in some examples, a function (e.g., a LUT) used to map a mean and/or a DC value (or other predictive block and/or an estimated reconstructed residual) to a scaling factor may be signaled from an encoder to a decoder. For example, signaling may include signaling information associated with any combination of the following types of functions: a linear model with a pre-defined slope and offset, a linear model with a signaled slope and/or offset, a linear model with a signaled set of slope and offset pairs, a lookup table, a piece-wise linear function, a piece-wise linear function with a signaled series of control points, polynomial function, a cubic function, etc.

Referring again to FIG. 2, as described above, a video block may be coded using an intra prediction. Intra prediction processing unit 212 may be configured to select an intra prediction mode for a video block to be coded. Intra prediction processing unit 212 may be configured to evaluate a picture and determine an intra prediction mode to use to encode a current block. Possible intra prediction modes may include planar prediction modes, DC prediction modes, and angular prediction modes. Further, it should be noted that in some examples, a prediction mode for a chroma component may be inferred from an intra prediction mode for a luma component. Intra prediction processing unit 212 may select an intra prediction mode after performing one or more coding passes. Further, in one example, intra prediction processing unit 212 may select a prediction mode based on a rate-distortion analysis. As illustrated in FIG. 2, intra prediction processing unit 212 outputs intra prediction data (e.g., syntax elements) to entropy encoding unit 220 and transform coefficient generator 204. As described above, a transform performed on residual data may be mode dependent.

Referring again to FIG. 2, inter prediction processing unit 214 may be configured to perform inter prediction coding for a current video block. Inter prediction processing unit 214 may be configured receive source video blocks and calculate a motion vector for PUs of a video block. A motion vector may indicate the displacement of a PU of a video block within a current video frame relative to a predictive block within a reference frame. Inter prediction coding may use one or more reference frames. Further, motion prediction may be uni-predictive (use one motion vector) or bipredictive (use two motion vectors). Inter prediction processing unit 214 may be configured to select a predictive block by calculating a pixel difference determined by, for example, sum of absolute difference (SAD), sum of square difference (SSD), or other difference metrics. As described above, a motion vector may be determined and specified according to motion vector prediction. Inter prediction processing unit 214 may be configured to perform motion vector prediction, as described above. As illustrated in FIG. 2, inter prediction processing unit 214 may be configured to generate a predictive block using the motion prediction data. For example, inter prediction processing unit 214 may locate a predictive video block within a frame buffer (not shown in FIG. 2). It should be noted inter prediction processing unit 214 may further be configured to apply one or more interpolation filters to a reconstructed residual block to calculate sub-integer pixel values for use in motion estimation. Inter prediction processing unit 214 may output motion prediction data for a calculated motion vector to entropy encoding unit 218. As illustrated in FIG. 2, inter prediction processing unit 214 may receive reconstructed video block via filtering unit 216. Filter unit 216 may be configured to perform deblocking and/or Sample Adaptive Offset (SAO) filtering. Deblocking refers to the process of smoothing the boundaries of reconstructed video blocks (e.g., make boundaries less perceptible to a viewer). SAO filtering is a non-linear amplitude mapping that may be used to improve reconstruction by adding an offset to reconstructed video data. As described above, a secondary process may include filtering, as such, filter unit 216 may be configured to receive quantization information (e.g., Q_{scale}) and perform filter based on received quantization information.

Referring again to FIG. 2, entropy encoding unit 218 receives quantized transform coefficients and predictive syntax data (i.e., intra prediction data and motion prediction data). It should be noted that in some examples, coefficient quantization unit 206 may perform a scan of a matrix including quantized transform coefficients before the coefficients are output to entropy encoding unit 218. In other examples, entropy encoding unit 218 may perform a scan. Entropy encoding unit 220 may be configured to perform entropy encoding according to one or more of the techniques described herein. Entropy encoding unit 218 may be configured to output a compliant bitstream, i.e., a bitstream that a video decoder can receive and reproduce video data therefrom. In this manner, video encoder 200 represents an example of a device configured to receive a level value, estimate a characteristic of a reconstructed video block associated with the level value, adjust a quantization scale factor based on the estimated characteristic, and perform a quantization process on the level value based on the adjusted quantization scale factor.

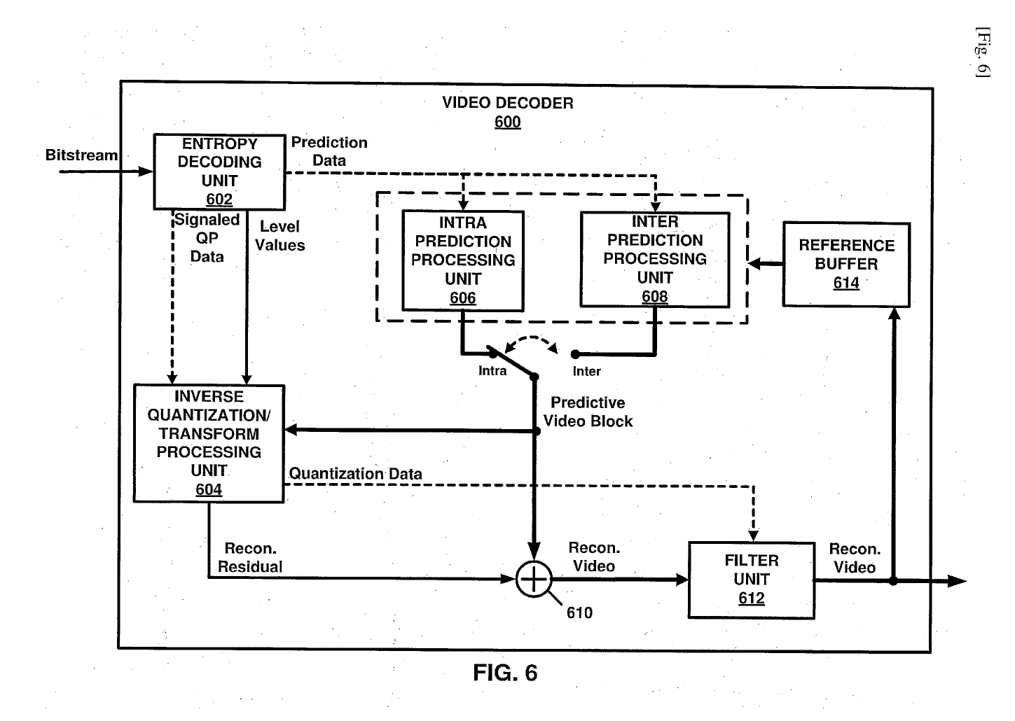

FIG. 6 is a block diagram illustrating an example of a video decoder that may be configured to decode video data according to one or more techniques of this disclosure. In one example, video decoder 600 may be configured to code transform coefficients according to the techniques described herein. Video decoder 600 may be configured to perform intra prediction decoding and inter prediction decoding and, as such, may be referred to as a hybrid decoder. In the example illustrated in FIG. 6 video decoder 600 includes an entropy decoding unit 602, inverse quantization/transform processing unit 604, intra prediction processing unit 606, inter prediction processing unit 608, summer 610, filter unit 612, and reference buffer 614. Video decoder 600 may be configured to decode video data in a manner consistent with a video coding standard. It should be noted that although example video decoder 600 is illustrated as having distinct functional blocks, such an illustration is for descriptive purposes and does not limit video decoder 600 and/or sub-components thereof to a particular hardware or software architecture. Functions of video decoder 600 may be realized using any combination of hardware, firmware, and/or software implementations.

As illustrated in FIG. 6, entropy decoding unit 602 receives an entropy encoded bitstream. Entropy decoding unit 602 may be configured to decode quantized syntax elements and quantized coefficients from the bitstream according to a process reciprocal to an entropy encoding process. Entropy decoding unit 602 may be configured to perform entropy decoding according any of the entropy coding techniques described above. Entropy decoding unit 602 may parse an encoded bitstream in a manner consistent with a video coding standard. As illustrated in FIG. 6, entropy decoding unit 602 may parse a bitstream in order to generate signaled QP data and level values. Examples of signaled QP data and level values are described above.

Inverse quantization/transform processing unit 604 may be configured to apply an inverse quantization and an inverse transformation to generate reconstructed residual data according to one or more of the techniques described above, that is inverse quantization/transform processing unit 604 may operate in a manner as described above with respect to inverse quantization/transform processing unit 208. For the sake for brevity, the discussion of inverse quantization/transform processing is not repeated, however reference is made to FIGS. 2-5 above, as well as the corresponding description. As illustrated in FIG. 6, at summer 610, reconstructed residual data may be added to a predictive video block. Summer 610 may add reconstructed residual data to a predictive video block and generate reconstructed video data.

A predictive video block may be determined according to a predictive video technique (e.g., intra prediction and inter frame prediction). Intra prediction processing unit 606 may be configured to receive intra prediction syntax elements and retrieve a predictive video block from reference buffer 614. Reference buffer 614 may include a memory device configured to store one or more frames of video data. Intra prediction syntax elements may identify an intra prediction mode, such as the intra prediction modes described above. Inter prediction processing unit 608 may receive inter prediction syntax elements and generate motion vectors to identify a prediction block (PB) in one or more reference frames stored in reference buffer 614. Inter prediction processing unit 608 may produce motion compensated blocks, possibly performing interpolation based on interpolation filters. Identifiers for interpolation filters to be used for motion estimation with sub-pixel precision may be included in the syntax elements. Inter prediction processing unit 608 may use interpolation filters to calculate interpolated values for sub-integer pixels of a reference block. Filter unit 612 may be configured to perform filtering on reconstructed video data. For example, filter unit 612 may be configured to perform deblocking and/or SAO filtering, as described above with respect to filter unit 216. Further, it should be noted that in some examples, filter unit 612 may be configured to perform proprietary discretionary filter (e.g., visual enhancements). As illustrated in FIG. 6, and as describe above, filter unit 612 may receive quantization data and may be configured to performing filter based on received quantization data.

Thus, as illustrated in FIG. 6, a video block may be output by video decoder 600. In this manner, video decoder 600 represents an example of a device configured to receive a level value, estimate a characteristic of a reconstructed video block associated with the level value, adjust a quantization scale factor based on the estimated characteristic, and perform a quantization process on the level value based on the adjusted quantization scale factor.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

Various examples have been described. These and other examples are within the scope of the following claims.

<Overview>

In one example, a method of performing a quantization process on a level value associated with video data, comprises receiving a level value, estimating a characteristic of a reconstructed video block associated with the level value, adjusting a quantization scale factor based on the estimated characteristic, and performing a quantization process on the level value based on the adjusted quantization scale factor.

In one example, a device for video coding comprises one or more processors configured to receive a level value, estimate a characteristic of a reconstructed video block associated with the level value, adjust a quantization scale factor based on the estimated characteristic, and perform a quantization process on the level value based on the adjusted quantization scale factor.

In one example, a non-transitory computer-readable storage medium comprises instructions stored thereon that, when executed, cause one or more processors of a device for coding video data to receive a level value, estimate a characteristic of a reconstructed video block associated with the level value, adjust a quantization scale factor based on the estimated characteristic, and perform a quantization process on the level value based on the adjusted quantization scale factor.

In one example, an apparatus for coding video data apparatus comprises means for receiving a level value, means for estimating a characteristic of a reconstructed video block associated with the level value, means for adjusting a quantization scale factor based on the estimated characteristic, and means for performing a quantization process on the level value based on the adjusted quantization scale factor.

The details of one or more examples are set forth in the accompanying drawings and the description below. Other features, objects, and advantages will be apparent from the description and drawings, and from the claims.

1. A method of performing a quantization process on a transform value associated with video data, the method comprising:
receiving a transform value;
receiving a predictive block of video data associated with the transform value;
adjusting a quantization scale factor based on a function of the received predictive block of video data; and
performing a quantization process on the transform value based on the adjusted quantization scale factor.

2. The method of claim 1, wherein performing a quantization process includes performing one of a forward quantization or an inverse quantization.

3. The method of claim 1, wherein the function includes a statistical function.

4. The method of claim 3, wherein the statistical function includes the mean of sample values included in the received predictive video block.

5. The method of claim 1, further comprising generating a reconstructed residual value using a result of the quantization process.

6. A method of performing a quantization process on a subset of transform values associated with video data, the method comprising:
receiving set of transform values;
determining a quantization parameter associated with the set of transform values;
performing a quantization process on a subset of the transform values based on the determined quantization parameter;
adjusting a quantization scale factor based on a function a result of the quantization process performed on the subset of the transform values; and
performing a quantization process on another set of transform values based on the adjusted quantization scale factor.

7. The method of claim 6, wherein the quantization process include one of quantization or inverse quantization.

8. The method of claim 6, wherein the set of transform values includes a DC component value and wherein another set of transform values include AC component values.

9. The method of claim 6, further comprising generating a reconstructed residual value using the result of the quantization process.

10. A method of scaling a transform value associated with video data, the method comprising:
receiving set of transform values;
determining a scaling factor based on a first subset of the transform values applying the scaling factor to a second subset of the transform values; and
performing a transform process on a set including the first subset of the transform values and the scaled second subset of transform values.

11. The method of claim 10, wherein the transform process is associated with a subsequent transform process.

12. The method of claim 11, wherein the transform process includes an inverse core transform process.

13. The method of claim 10, further comprising generating a reconstructed residual value using a result of the transform process.

14-22. (canceled)

23. A device for coding video data, the device comprising one or more processors configured to perform any and all combinations of the steps of claim 1.

24. The device of claim 23, wherein the device includes a video encoder.

25. The device of claim 23, wherein the device includes a video decoder.

26. An apparatus for coding video data, the apparatus comprising means for performing any and all combinations of the steps of claim 1.

27. A non-transitory computer-readable storage medium comprising instructions stored thereon that, when executed, cause one or more processors of a device for coding video data to perform any and all combinations of the steps of claim 1.
